(19) United States
(12) Patent Application Publication
(10) Pub. No.: US 2007/0196152 A1
(43) Pub. Date: Aug. 23, 2007

(54) SHEET FEEDING APPARATUS AND IMAGE FORMING APPARATUS

(76) Inventors: Keisuke Shimizu, Sagamihara City (JP); Takamasa Shiraki, Yokohama City (JP); Masahiko Yamada, Mchida City (JP); Kazushige Kawamura, Yokohama City (JP); Takayuki Andoh, Yokohama City (JP); Hiroshi Ishii, Yokohama City (JP); Takeshi Washio, Chigasaki City (JP); Kohta Takenaka, Yokohama City (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/624,545

(22) Filed: Jan. 18, 2007

(30) Foreign Application Priority Data
Feb. 20, 2006 (JP) 2006-042600

(51) Int. Cl. G03G 15/00

(52) U.S. Cl. 399/405

(57) ABSTRACT

A sheet feeding apparatus includes a fixing device to fix a toner image by heat, a discharging tray to accommodating a sheet fixed toner image at the fixing device, a sheet feeding device including a sheet discharging roller to discharge the sheet and positioned downstream of the fixing device, and a sheet cooling device to cool the sheet fixed toner image. The sheet cooling device is located along the direction in which the sheets are stacked and is close to the sheet discharging device. Blocking from adhesion of sheets to each other by melting toner may be prevented by cooling the discharged sheet efficiently after the fixing.

### CROSS-REFERENCE TO RELATED APPLICATIONS

The present application claims priority to Japanese Patent Application No. 2006-042600 filed in the Japanese Patent Office on Feb. 20, 2006, the entire disclosure of which is incorporated herein by reference.

### BACKGROUND OF THE INVENTION

1. Field of the Invention

The present invention relates to a sheet feeding apparatus and an image forming apparatus, and specifically that includes a cooling device that cools a sheet heated by the fixing device when the sheet is discharged.

2. Description of the Related Art

In an image forming apparatus such as a copy machine, a printer, a facsimile, etc., after developing a latent image into a visible image on an image bearing member, the toner image is transferred to the sheet by static charging and a fixing device fixes the toner image, and thereby printed material is made.

One type of such a fixing device is a heat roller system that includes a heating roller and a pressure roller. The heating roller and the pressure roller are provided to oppose each other in a sheet feeding path, and a sheet is heated and pressed while the sheet is fed by the heating roller and the pressure roller. A toner image is melted and permeated into the sheet by heating and pressure, and then fixed to the sheet via hardening by cooling. The heat roller system is utilized in many image forming apparatuses because it allows speeding up printing speed by its high heat efficiency, it can heat the sheet stably by its high efficiency of heat transfer, and it may have a simple design by feeding the sheet while heating the sheet.

The sheet after the fixing is discharged to a discharging tray by a sheet feeding device including discharging rollers provided nearby the heating roller and the pressing roller.

However, the sheet after being fixed may be heated to a high temperature, sometimes the temperature may surpass 100° C. In a case of performing a series of printings, a toner image that is not sufficiently cooled and hardened likely may be rubbed by a subsequent sheet when the subsequent sheet is discharged on a stack of sheets on the discharging tray. The fixed toner image may then be peeled off by re-melting of the fixed toner image because of heat accumulation in the stack of sheets. The re-melting of the fixed toner image may cause “blocking”, i.e. an adhesion between a subsequent printed sheet and a previous printed sheet.

Japanese Patent Laid-Open Application No. 1999-167232 discloses a sheet cooling device that contacts a sheet discharged to the sheet discharging tray. Specifically, the sheet cooling device is cooled by a heat sink and a fan is provided in a sheet feeding path.

Japanese Patent Laid-Open Application No. 2001-242769 and Japanese Patent Laid-Open Application No. 2002-72729 disclose a sheet cooling device blowing air to discharged sheets. Specifically, air via a fixing device is blown on the stack of sheets from above the stack of sheets.

Japanese Utility Model Laid-Open Application No. 1992-44251 discloses a fan that supplies air to a stack of sheets from beneath. Specifically, the fan is provided nearby the sheet discharging device.

Japanese Utility Model Laid-Open Application No. 1987-140058 discloses plural air exhaust ducts connected to one air supplying duct on a side wall of a sheet discharging tray along a sheet discharging direction.

However, the cooling devices to prevent the blocking of sheets in the above noted references have some problem as now discussed.

In the apparatus disclosed in Japanese Patent Laid-Open Application No. 1999-167232, because the sheet is cooled at a discharging tray area, the effect of cooling may not be adequately obtained between the discharging device and the discharging tray. If additional cooling mechanisms are provided between the discharging device and the discharging tray, the number of parts may increase or the machine width may have to be lengthened to increase a length of a cooling area.

In the apparatuses disclosed in Japanese Patent Laid-Open Application No. 2001-242769 and Japanese Patent Laid-Open Application No. 2002-72729, only the topmost sheet is cooled substantially and sheets inside the stack of sheets are not significantly cooled because the air via the fixing device is blown on the stack of sheets from above the stack of sheets. The blocking by adhesion of the toner may then not be solved because the problem of heat accumulation in the sheet stack is not solved.

In the apparatus disclosed in Japanese Utility Model Laid-Open Application No. 1992-44251, the cooling device is applied only to a discharging sheet before stacking and thereby the heat accumulation of the sheet stack may not be solved, and thus the blocking by adhesion of the toner may not be solved adequately similarly as in Japanese Patent Laid-Open Application No. 2001-242769 and Japanese Patent Laid-Open Application No. 2002-72729.

In the apparatus disclosed in Japanese Utility Model Laid-Open Application No. 1987-140058, because the air is blown to an entire area in a direction of sheet discharging of the sheet discharging tray, a stream length of the cooling air becomes long and a needed structure becomes more complex. Additionally, the sheet being discharged is not cooled when a discharging roller discharges the sheet because the air is supplied only to the sheet discharged on the stack on the discharging tray. If the sheet being discharged touches the stack of sheets, the blocking by adhesion of toner may still occur.

Recently, downsizing of such image forming machines is desired, and thereby the length of a sheet feeding path between a fixing device and a discharging device is being decreased. In this case, it is difficult to provide a cooling device between the fixing device and the discharging device because the length of the sheet feeding path between the fixing device and the discharging device is decreased. The cooling of a toner image after fixing may then not be accelerated. Especially in a case of a full color copying machine that has a greater density of parts than a black and white copying machine, the length of the space between the fixing device and the discharging device is too short to provide a cooling device because the length of the space between the fixing device and the discharging device may be occupied by other parts, such as a sheet feeding device and a sheet feeding detector provided around the fixing device.

In a case mentioned above, the flow of air can be generated by a cooling fan to provide a cooling device on the sheet feeding path. However, this may be detrimental to operation of a device such as a detector as a temperature at the detector may rise over an acceptable temperature value because heated air nearby the fixing device flows to the area including the detector provided nearby the fixing device.

### SUMMARY OF THE INVENTION

The present invention has been conceived in response to one or more problems of the related art, and one of the objects of the present invention is to provide a novel sheet feeding apparatus and a novel image forming apparatus reducing the blocking of sheets adhering to each other by melted toner.

A more specific object of the present invention is to cool a discharged sheet efficiently after fixing and to prevent adverse affects to devices around the fixing device even if a sheet feeding length between a fixing device and a discharging device is short.

A more specific object of the present invention is to provide a novel sheet feeding apparatus including a fixing device to fix a toner image by heat, a sheet accommodating device to accommodate a sheet with a fixed toner image at the fixing device, a sheet feeding device including a sheet discharging device to discharge the sheet to a downstream position of the fixing device, and a sheet cooling device to cool the sheet with the fixed toner image. The sheet cooling device is located along the direction in which the sheets are stacked and is located close to the sheet discharging device.

With the structure of the present invention, a sheet is effectively cooled even when the temperature of the sheet is high because the sheet cooling device is provided nearby the discharging position. Also, with the structure in the present invention, substantially the entire stack of sheets is cooled by the sheet cooling device located along the direction in which the sheets are stacked, and thereby blocking may be more effectively prevented than when only a topmost sheet is cooled.

### BRIEF DESCRIPTION OF THE DRAWINGS

A more complete appreciation of the present invention, and many of the attendant advantages thereof, will be readily obtained as the same becomes better understood by reference to the following detailed description when considered in connection with the accompanying drawings.

FIG. 1 is a cross-section view showing an overall configuration of an image forming apparatus according to an embodiment of the present invention.

FIG. 2 is a perspective view of a sheet discharging tray shown as a substantial part of the sheet feeding device of the image forming apparatus according to an embodiment of the present invention of FIG. 1

FIG. 3 is a perspective view of the sheet discharging tray of FIG. 1 attached to the body of the sheet image forming apparatus according to an embodiment of the present invention of FIG. 1.

FIG. 4 is a cross-section view showing a configuration of a sheet discharging device and sheet stack after fixing to explain a reason why a cooling device is needed.

FIG. 5 is a horizontal sectional view of orifices configured to a sheet feeding apparatus according to an embodiment of the present invention.

FIG. 6 is a horizontal sectional view of orifices configured to a sheet feeding apparatus according to an embodiment of the present invention.

FIG. 7 is a rear perspective view of an air supplying device of a cooling device according to an embodiment of the present invention.

FIG. 8 is a horizontal cross-section view showing a sheet discharging tray configured to supply air from a fan to orifices according to an embodiment of the present invention.

FIG. 9 is a vertical cross-section view showing a sheet discharging tray configured to supply air from a fan to orifices according to a further embodiment of the present invention.

FIG. 10 is a block diagram illustrating construction of an embodiment of a fan controlling system of an embodiment of the present invention.

FIG. 11 is a cross-section view showing a sheet feeding apparatus including a sheet feeding path and a temperature detector according to an embodiment of the present invention.

FIG. 12 is a flow diagram showing operations of an embodiment of a fan controlling system of FIG. 10.

FIG. 13 is a flow diagram showing operations of an embodiment of a fan controlling system of FIG. 10.

FIG. 14 is a flow diagram showing operations of an embodiment of a fan controlling system of FIG. 10.

FIG. 15 is a flow diagram showing operations of an embodiment of a fan controlling system of FIG. 10.

FIG. 16 is a perspective view of orifices of a cooling device of a sheet feeding apparatus according to an embodiment of the present invention.

### DETAILED DESCRIPTION OF THE PREFERRED EMBODIMENTS

Preferred embodiments of the present invention are described in detail referring to the drawings, wherein like reference numerals designate identical or corresponding parts throughout the several views.

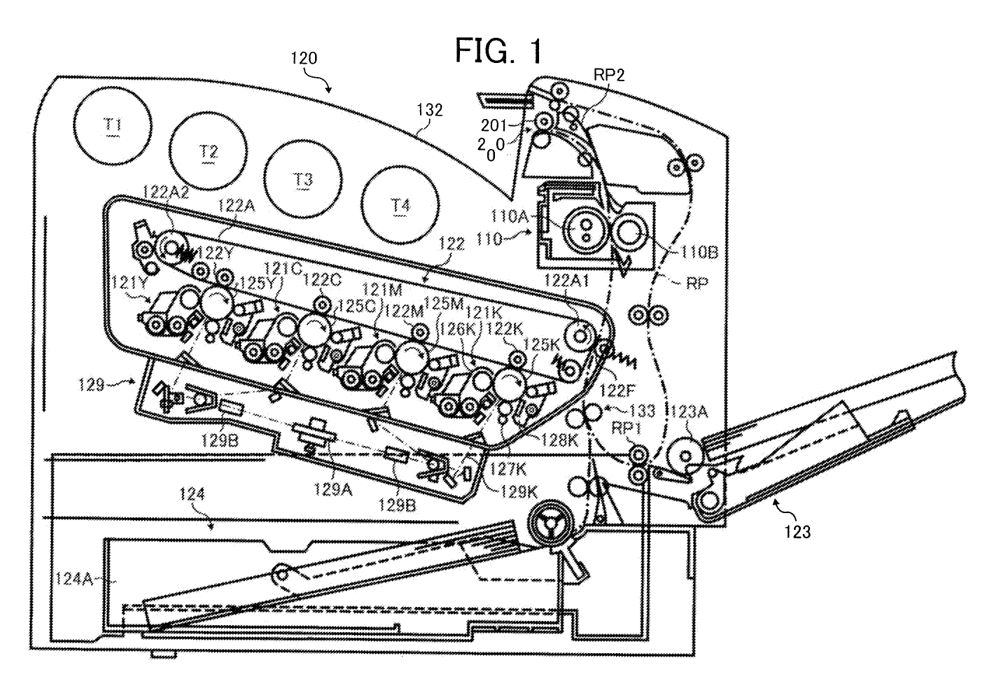

FIG. 1 is a cross-section view showing an overall configuration of an image forming apparatus 120 including a sheet feeding apparatus according to an embodiment of the present invention.

As illustrated in FIG. 1, the image forming apparatus 120 is adopted as a four photoconductor drum tandem color printer configured to print a full color image. The image forming apparatus may be a copy machine, a facsimile, a printing machine, etc.

As illustrated in FIG. 1, image forming apparatus 120 includes the following devices.

Image forming devices 121Y, 121M, 121C, 121K are provided each for forming a color image of yellow (Y), magenta (M), cyan (C), black (K), respectively, as an original image. An image transfer device 122 includes first transfer rollers 122Y, 122M, 122C, 122K opposite to respective image forming devices 121Y, 121M, 121C, 121K, and a manual sheet feeding tray 123 and registration roller pair 133 are provided to manually supply a sheet.

A sheet feeding cassette 124A is provided in a sheet supplying apparatus 124, the registration roller pair 133 being configured to feed a sheet fed from the manual sheet feeding tray 123 or the sheet supplying apparatus 124 to the image forming devices 121Y, 121M, 121C, 121K. A sheet fixing device 110 is configured to fix a toner image transferred onto the sheet.

The sheet fixing device 110 can utilize a heat roller system that includes a heating roller 110A and a pressure roller 110B. The heating roller 110A and the pressure roller 110B are provided to oppose each other in the sheet feeding path, such that the sheet is heated and pressed while the sheet is fed by the heating roller 110A and the pressure roller 110B. A toner image is melted and permeated into the sheet by heating and pressure in the fixing device 110.

Image transfer device 122 includes a belt 122A (described as a “transfer belt”) as a transfer medium, provided around rollers 122A1, 122A2. The first transfer rollers 122Y, 122M, 122C, and 122K are provided at each respective transfer position of respective photoconductor drums 125Y, 125M, 125C, and 125K and the transfer belt 122A facing the photoconductor drums. By applying a counter charge of the toner provided by the image transfer devices 122Y, 122M, 122C, and 122K, the image transfer devices 122Y, 122M, 122C, and 122K transfer the toner image formed in the image forming devices 121Y, 121M, 121C, 121K. Transfer device 122 provided on the sheet feeding path includes a second transfer device 122F configured to transfer the toner image formed on the transfer belt 122A to the sheet. It is possible for the image forming apparatus 120 to use sheets of plain paper usually used in a copy machine, or a particular sheet having a larger amount of heat capacity than the plain paper including an OHP (overhead projector) sheet, a card or a postcard such as 90K papers, a cardboard heavier than 100 g/m², envelopes, etc.

As illustrated in FIG. 1, each image forming device 121Y, 121M, 121C, and 121K forms a toner image by toner of a respective color. Because each image forming device has the same construction, the image forming device 121K is explained as representative of all the image forming devices. The image forming device 121K includes a photoconductor drum 125K bearing a latent image by static charge, a charging device 127K, a developing device 126K, and a cleaning device 128K positioned in this in order in a rotating direction of the photoconductor drum 125K.

A latent image according to image data of black color is formed by a laser beam 129K from an image writing device 129 provided between the charging device 127K and the developing device 126K. As the latent image bearing member, the photoconductor drum 125K or alternatively a photoconductor belt is available. The image forming devices provided around the photoconductor drum 129K can be accommodated in a unit as a process-cartridge (not shown).

With the illustrated image forming apparatus 120 in FIG. 1, it is possible to shorten its overall length because the transfer device 122 is provided in a slanted or sloped structure in the image forming apparatus 120.

An image is formed in the following processes and conditions in the image forming apparatus 120. The image forming device 121K is again explained as a representative, but each image forming device 121Y, 121M, 121C has the same construction as the image forming device 121K and operates in the same manner.

While image forming, the photoconductor drum 125K is driven and rotated by a motor (not shown), which is neutralized by an AC-Bias charge (non DC-Bias) from charging device 127K. An electrical potential of the photoconductor drum 125K is set to, e.g., −50 volts as a standard potential. The photoconductor drum 125K is uniformly charged to substantially equal potential of DC component by the DC-Bias added AC-Bias by charging device 127K. A surface potential is set from, e.g., −500 volts to −700 volts (a desired surface potential is set by a process controller). After uniformly charging, a writing process begins. An object image is written by the writing device 129 according to digital image data sent from a controller (not shown). In the writing device 129, according to the black color digital image data, a laser 129K beam from a laser beam source by an emission signal digitalized for a laser diode irradiates the photoconductor drum 125K, as representative of an image of the color bearing member, through a cylinder-lens (not shown), polygon-motor 129A, Fθ-lens 129B, a first-third mirror (not shown), and WTL-lens (not shown). The surface electric potential of the parts of the photoconductor 125K irradiated by the laser beam is nearly −50 volts to thereby form a latent image according to the image data.

The electro-static latent image formed on the photoconductor drum 125K is then developed by developer 126K using the appropriate color toner (black in this instance). In the developing process, by applying, e.g., DC: −300[V] to DC: −500[V] added AC Bias voltage to a developing sleeve, toner (Q/M: −20[μC/g] to −30[μC/g]) is developed to a part of the photoconductor drum 125K with a charge reduced by the laser beam 129K from the writing device 129. The color toner image developed by the developing process is then transferred to the sheet fed by the registration roller pair 133 that is operated at an appropriate timing. Before the sheet reaches the transfer belt 122A, the toner image is adsorbed to the transfer belt 122A by electrostatic adsorption by applying an adsorption charge by a sheet adsorption bias applying operation. The toner image is then transferred electrically to the transfer belt 122A from the photoconductor drum 125K by applying an opposite electrical bias-voltage to the toner charge from the first transfer roller 122K included in the transfer device 122.

The above operations are then repeated for the other image forming devices 121M, 121C, 121Y, and images of black, magenta, cyan, and yellow and then superposed on each other on the transfer belt 122A.

A second transfer bias device 122F then transfers the superposed toner images of the different colors to the sheet at once. The sheet after having the toner image transferred thereto is separated nearby the drive roller 122A1 by curvature from transfer belt 122A, and is then fed to the fixing device 110. By passing through a fixing nip portion configured by the fixing roller 110A and pressure roller 110B, the toner image is fixed to the sheet and the sheet is discharged to the discharging tray 132.

With the image forming apparatus illustrated in FIG. 1, the image forming apparatus can form an image on the sheet discharged from the fixing device 110 not only on one side but also on two sides. In the two sides image forming mode, the sheet after the fixing is fed through a reversal circulation path RP to registration roller pair 133 by a sheet feeding roller pair RP1 positioned at the end of the reversal circulation path RP and utilizing the sheet feeding roller 123A of the manual sheet feeding tray 123. A sheet feeding path selecting guide RP2 provided downstream of the sheet feeding direction of the fixing device 110 selects the sheet feeding path for single side image forming or dual side image forming.

The sheet feeding path selecting guide RP2 is included in a sheet feeding device to switch the sheet feeding path based on a sheet forming condition.

The charge potentials and other characteristic values noted above are not limited to the values above mentioned and it is possible to change the values related to variations of color or image density.

In FIG. 1 T1 to T4 indicate toner supply tanks for storing developers.

As noted above, in the image forming apparatus 120, transfer belt 122A in transfer device 122 may be provided in a slanted or sloped structure to shorten the height of the image forming apparatus 120. Thereby, the sheet feeding path from a second transfer position through the fixing device 110 to the discharging tray 132 can be shortened. As a result, the sheet fed from the second transferring position to the discharging tray 132 only has a short time to cool the sheet heated by the fixing device 110. Without any cooling device, sheets may adhere to each other from the above-discussed “blocking” phenomenon.

In this embodiment, a sheet cooling device is provided at a sheet feeding device discharging the sheet to the discharging tray 132 fed from the fixing device 110. As illustrated in FIG. 1, the sheet feeding apparatus 200 includes a sheet discharging tray 132 configured to accommodate a stack of sheets and a discharging roller 201 configured to discharge the sheets after an image is fixed thereon.

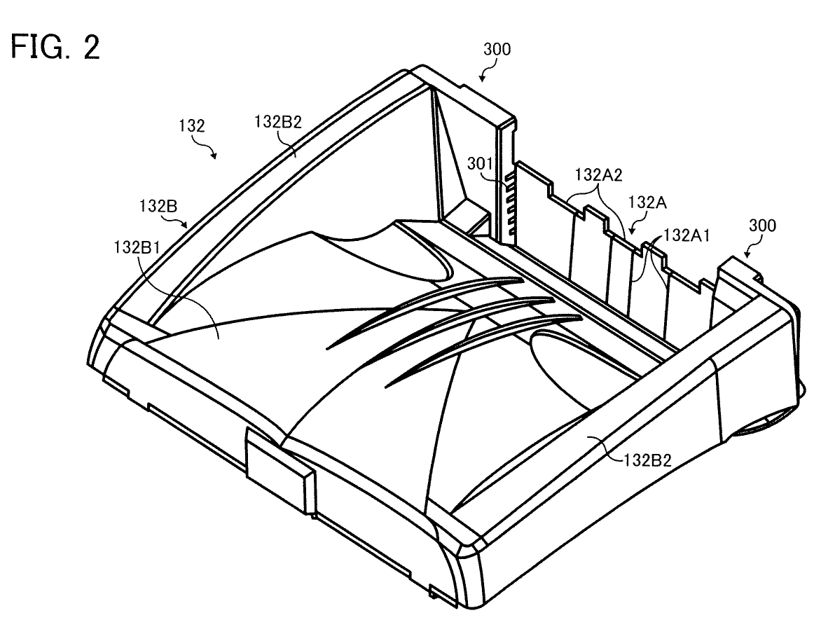

FIG. 2 is a perspective view of the sheet discharging tray 132. In FIG. 2, the sheet discharging tray 132 is molded and includes an upper part 132A provided upstream in the sheet discharging direction and a lower part 132B provided downstream of the upper part 132A in the sheet discharging direction. In the upper part 132A, a rib 132A1 is formed in a surface as a protruding portion confronting the lower part 132B along the width direction perpendicular to the sheet discharging direction. In the upper part 132A, a plurality of cutout portions 132A2 are provided at a top edge along the width direction perpendicular to the sheet discharging direction. The rib 132A1 is configured to order the trailing edge of the discharged sheet and to make the sheet slip down smoothly.

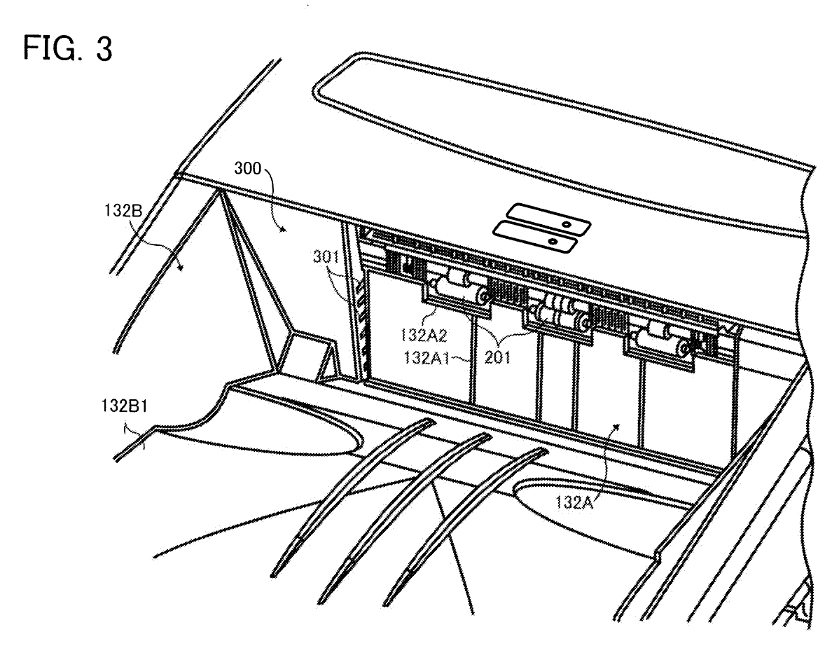

As illustrated in FIG. 3, cutout portions 132A2 are configured to accommodate discharging rollers 201 that can pinch and feed the sheet after fixing. The lower part 132B is a sheet accommodating part including a sheet accommodating surface 132B1 and a sidewall 132B2. The sheet accommodating surface 132B1 has a sloped portion, because the upstream portion adjacent to the upper part 132A is lower than the downstream portion of the sheet feeding direction. With that structure, it is possible to move the sheets toward the ribs 132A1 of the upper part 132A and order the trailing edge of the sheets.

As illustrated in FIG. 2, the width of the upper part 132A perpendicular to the sheet feeding direction is narrower than the width of the sheet accommodating surface 132B1 of the lower part 132B.

A cooling device 300 having a hollow is provided as another part of the upper part 132A and the lower part 132B. However, it is also possible to mold the cooling device 300 integrally with a leading edge shaped as a folding back part of the side wall 132B2.

The cooling device 300 can be configured as a body as high as sidewall 132B2. In this embodiment, as one wall of the cooling device 300 faces the surface of the upper part 132A formed rib 132A1, the cooling device 300 is positioned at substantially the same position as or close to the discharging position, and is thereby close to the discharging roller 201.

The cooling device 300 being located at substantially the same position or close to the discharging position provides the benefit that more efficient cooling of a discharge sheet can be realized. In that respect in the embodiment shown for example in FIG. 2 the cooling device 300 is provided near or at the upstream edge or at a most upstream portion of the discharging tray 132, relative to the flow of a paper sheet. Thereby, the cooling device 300 is close to the discharging position or as close as possible to the discharging position.

At the wall facing the surface of the upper part 132A, orifices 301 are provided as air ducts to induct air to the sheets along the direction in which the sheets are stacked (vertical direction). A plurality of orifices 301 can be provided located nearby both or one side of the upper part 132A along the direction in which the sheets are stacked.

In this embodiment, each opening area of the orifice 301 is different from another one. As illustrated FIG. 2, the higher the orifices 301, the larger the opening area of the orifice 301. The reason for that structure is as follows.

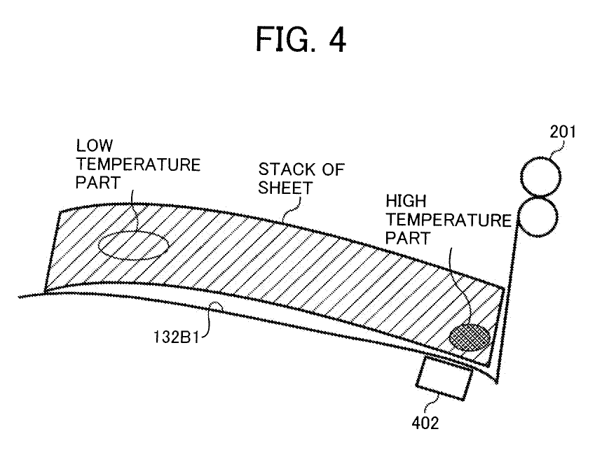

FIG. 4 shows how heat is radiated from a stack of sheets. As illustrated in FIG. 4, in a sheet discharged to discharging tray 132, the downstream part of the sheet radiates heat more than the upstream part of the sheet because the contact time to air of the downstream part of the sheet is longer than the upstream part of the sheet, and thereby the downstream is cooled more (which is illustrated as the “low temperature part”).

On the other hand, the upstream part of the sheet previously discharged by the discharging roller 201 may contact with the upstream part of the sheet subsequently discharged by the discharging roller 201 after only a short time on the sheet accommodating surface 132B1. A lower part of the middle to the upstream part of the stack of sheets thereby does not have a long time to contact with enough air to cool, and thereby heat may remain and a high temperature part arises in the lower part of the middle to the upstream part of the stack of sheets (which is illustrated as the “high temperature part”).

In this embodiment, a plurality of the orifices 301 to induct air are provided nearby the discharging position of the discharging roller 201. The orifices 301 supply air to the high temperature position of the stack of sheets to cool the stack more effectively. A topmost sheet of the stack discharged by discharge roller 201 may be the hottest in the stack of sheets. The structure and positioning of the orifices 301 is effective to radiate heat as more air flows around the topmost sheet. Additionally, the heat tends to rise up in the stack of sheets. For that reason, the topmost orifice of orifices 301 has the largest opening area. As illustrated in FIG. 2, the orifices 301 are formed parallel to the sheet discharging direction nearby the discharging point to supply air from a direction perpendicular to the sheet discharging direction. The orifices 301 can thus cool both a sheet being discharged and a heat spot of the stack of sheets positioned below the discharging roller 201. Additionally, because air from the orifices 301 can cool the heated sheet that is being discharged before that sheet lands on the stack of sheets, toner is better fixed and the blocking phenomena can be prevented.

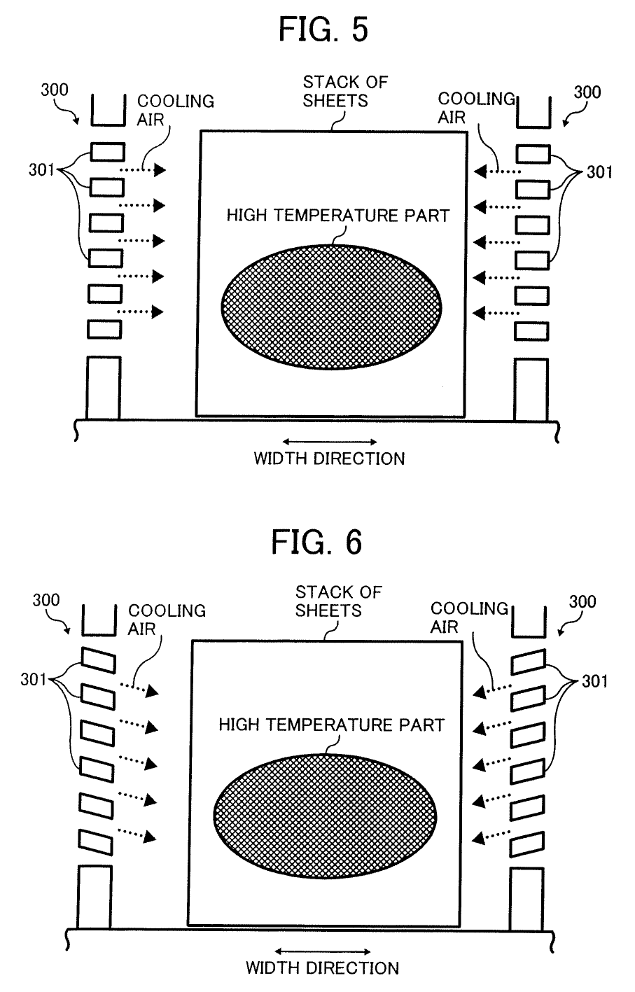

As illustrated in FIG. 5, because the orifices 301 can induct fresh air, the fresh air flows naturally through the orifices 301 from the difference of air density if the temperature is different between the heated sheet and the fresh air, without motive energy. In this embodiment, the direction of air flow through orifices 301 is set to the width direction of the stack of sheets as illustrated in FIG. 5, or can be skewed from the top down as illustrated in FIG. 6. The orifices 301 as illustrated in FIG. 5 or FIG. 6 can increase efficiency of contact between fresh air and the stack of sheets. Specifically, the orifices 301 as illustrated in FIG. 5 or FIG. 6 can induct fresh air to an inner portion of the stack of sheets that tends to retain its heat.

The fresh air from the orifices 301 can also be inducted by motive energy instead of relying on natural air flow as mentioned above. Details of that structure now follow.

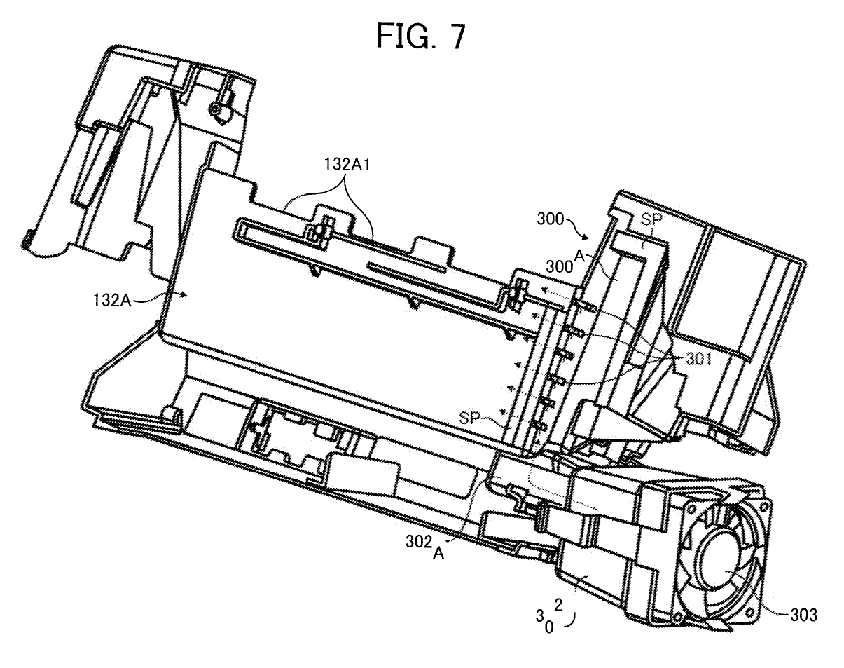

In this embodiment, a cooling fan is provided to supply motive energy for supplying air to orifices 301. In FIG. 7, the upper part 132A of sheet discharging tray 132 is illustrated from behind.

The cooling device 300 includes the hollow 300A inside, the orifices 301, a duct 302 having a spurt part 302A connected to the hollow 300A, and a cooling fan 303 connected to the end of duct 302 opposite to the orifices 301. Reference indicator SP is a sponge used as a seal. The seal SP may prevent leaking of air from the hollow 300A of the cooling device 300 except through orifices 301.

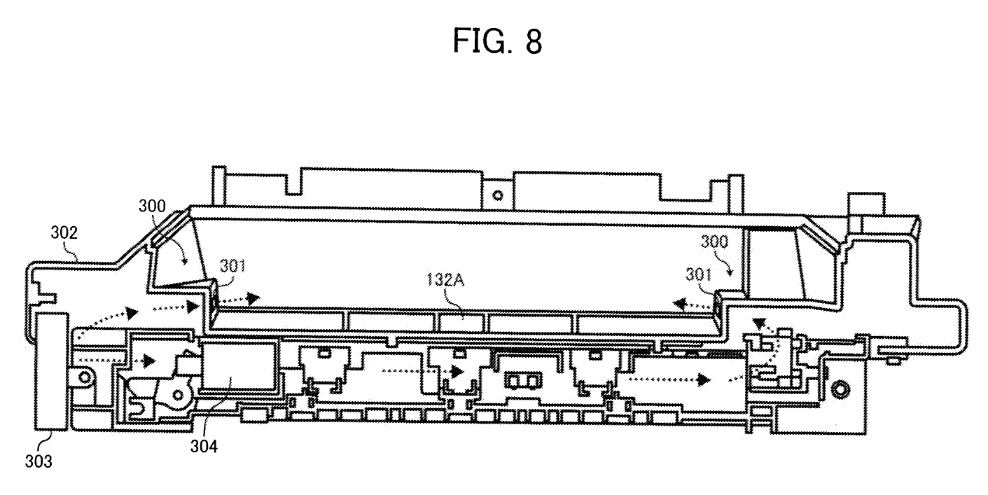

FIG. 8 is a horizontal cross-section view showing the upper part 132A including the cooling fan 303 provided on one side portion in the width direction of the upper part 132A. The cooling fan 303 is attached to the end of the duct 302 that faces outside of the sheet feeding apparatus 200. The air inducted by the cooling fan 303 flows along a first path to orifices 301 of the cooling device 300 and along a second path including a solenoid 304 to switch the sheet feeding path provided nearby the cooling fan 303, as shown by the arrows in FIG. 8. A current plate (not shown) to separate the air inducted by the cooling fan 303 to the first path and the second path can be provided nearby the cooling fan 303. The cooling fan 303 can be provided on one side portion as illustrated in FIG. 8.

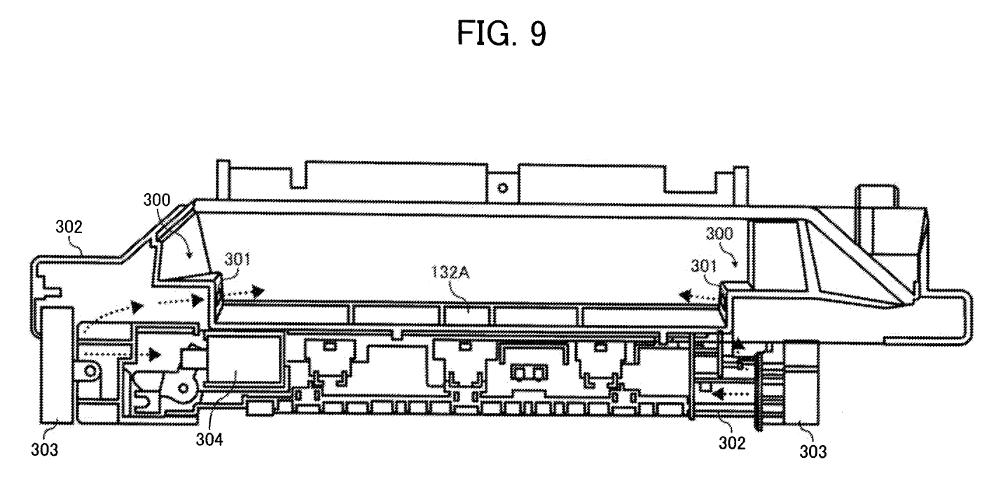

As another embodiment shown in FIG. 9, two cooling fans 303 can be provided, one on each side portion of the duct 302 to provide air to the duct 302 and the orifices 301 on both sides of a sheet width direction. The cooling device as illustrated in FIG. 9 can have substantially equal flow volume at each side, and thereby the efficiency of having cooling air to cool a hot spot of the stack of the sheets can be increased compared with having one fan only on one side. As the cooling fan 303 is attached to the end of duct 302, the leaking noise of the fan 303 is also decreased when the fan 303 works.

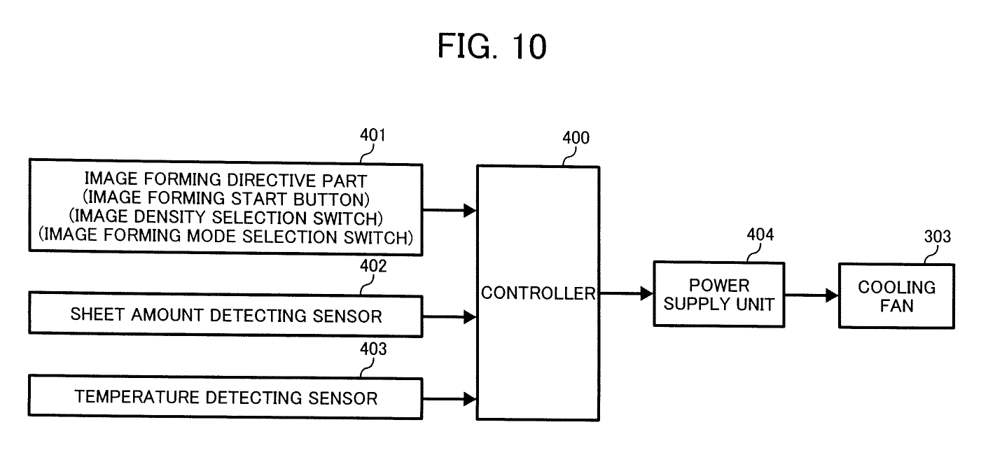

Additionally, as shown in FIG. 10, a controller 400 can be provided to control working timing and air volume of the fan 303, and thereby the stack of sheets may be more efficiently cooled properly and noise of the fan may be decreased. FIG. 10 shows a block diagram including a controller 400 to explain how the controller 400 works.

The controller 400 includes a microcomputer (not shown) for image processing as a principal part and an I/O (Input/Output) interface (not shown). An image forming directive part 401, a sheet amount detecting sensor 402, and a temperature detecting sensor 403 that detects an air temperature of the sheet feeding path between the sheet fixing device 110 to the sheet discharging tray 132 are connected to the controller 400 through its I/O (Input/Output) interface as an input device. A power supply unit 404 of the fan 303 is connected to the controller 400 through its I/O (Input/Output) interface as an output device.

The image forming detective part 401 is configured as an operation panel attached to the main body of the image forming apparatus 120. By the image forming directive part 401, a user can start an image forming process and select image forming conditions such as image density relating to toner mass on the photoconductor and a color-mode, such as a mono-color (for example black and white) or full-color. By the image forming directive part 401, a user can also select a one side or two side image forming mode. As illustrated in FIG. 4, the sheet amount detecting sensor 402 can detect a weight of the stack of sheets provided to the sheet accommodating surface 132B1 of the lower part 132B nearby the high temperature part of the stack of sheets. For example, the sheet amount sensor 402 may be configured by a piezoelectric-device. The sheet amount sensor 402 is used to assess the difficulty of radiation of heat of the sheet discharged previously when the amount of the sheets increases over a predetermined weight.

As illustrated in FIG. 11, the temperature detecting sensor 403 detects an air temperature on the sheet feeding path PS of the sheet feeding apparatus 200 between the sheet fixing device 110 and the sheet discharging tray 132 via the sheet discharging roller 201. When the sheet is discharged from the sheet fixing device 110, the temperature detecting sensor 403 detects air temperature. If the temperature detecting sensor 403 detects a temperature high enough to make the toner melt, the temperature detecting sensor 403 sends out signals to work the cooling fan 303 to the controller 400. Additionally, in FIG. 11, character RPP indicates a reflection guide, character RP2 indicates a sheet feeding path selecting guide, and character PSA indicates a reflection sheet feeding path. As noted above, one object of the present invention is to prevent blocking of an adhesion of sheets relating to melting of toner. Specifically, whether the blocking occurs is based on a material of the sheets, a mass of the toner on the sheets, and the image forming mode.

Additionally, it is desired to decrease the noise of fan 303 by reduction of unnecessary work of the fan 303 and to still cool the sheets effectively.

To achieve the above results, the controller 400 can execute the following processes.

(1) The fan 303 is driven in a duplex image forming mode.

(2) The fan 303 is driven if the amount of sheets (W) reaches a predetermined value (W0). In this embodiment, the predetermined value (W0) may be set to, e.g., 100 print to 300 print of A4 size.

(3) The fan 303 is driven if the air temperature of the sheet feeding path reaches a predetermined value. In this embodiment, the predetermined value may be set to, e.g., 60° C.

(4) The fan 303 is driven in an image adjustment mode. The image adjustment mode means, for example, adjusting some parameters of the writing device or the developing device to satisfy predetermined conditions by detecting a decrease in image quality of each color, such as by detecting density of toner images formed as layers of each of color toner patches on the transfer belt.

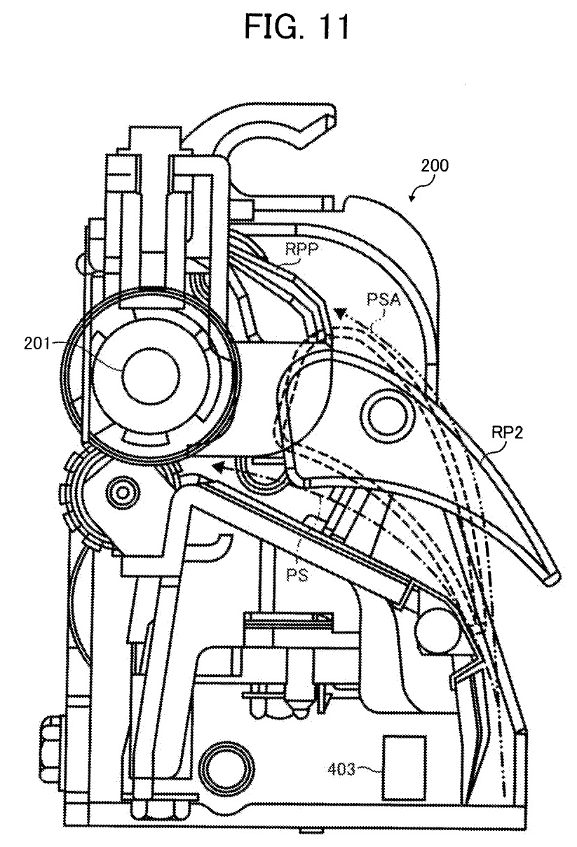

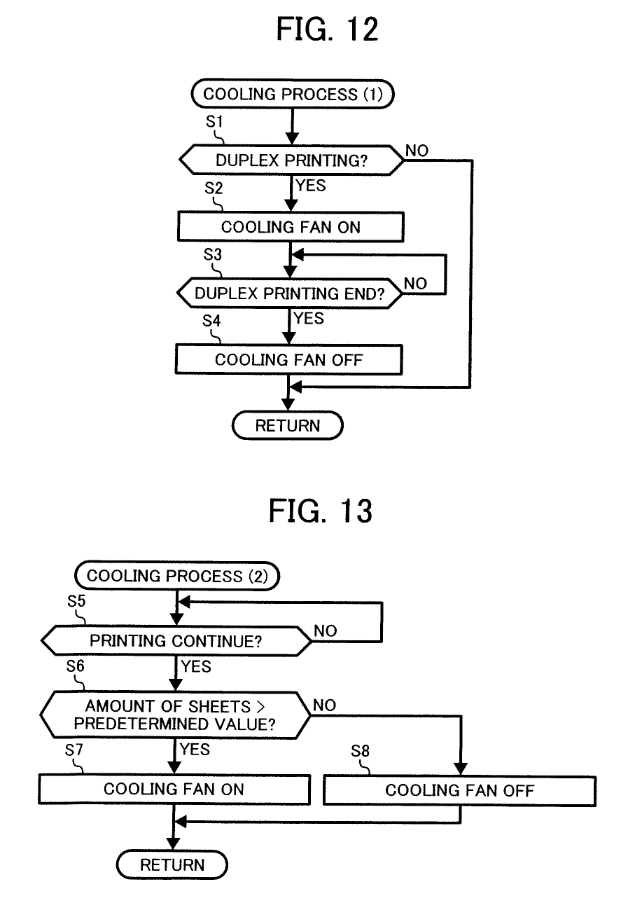

FIG. 12 shows a flow chart of the cooling process (1). In the case of a duplex image forming mode (YES in S1), the image forming directive part 401 sends a signal to the power supply unit 404 for the fan 303 to be driven (in S2) until the end of duplex image forming mode (until YES in S3). Then when the duplex image forming is ended (YES in S3) the fan 303 is turned off (in S4).

FIG. 13 shows a flow chart of the cooling process (2). It is first determined if printing is continuing in S5, and when YES in S5 the operation proceeds to S6. In the case the amount of sheets (W) stacked on the discharge tray 132 reaches a predetermined value (W0) (YES in S6), the image forming directive part 401 sends a signal to the power supply unit 404 for the fan 303 to be driven (in S7) until the stack of sheets are removed (until NO in S6). When NO in S6 the cooling fan 303 is turned off (in S8).

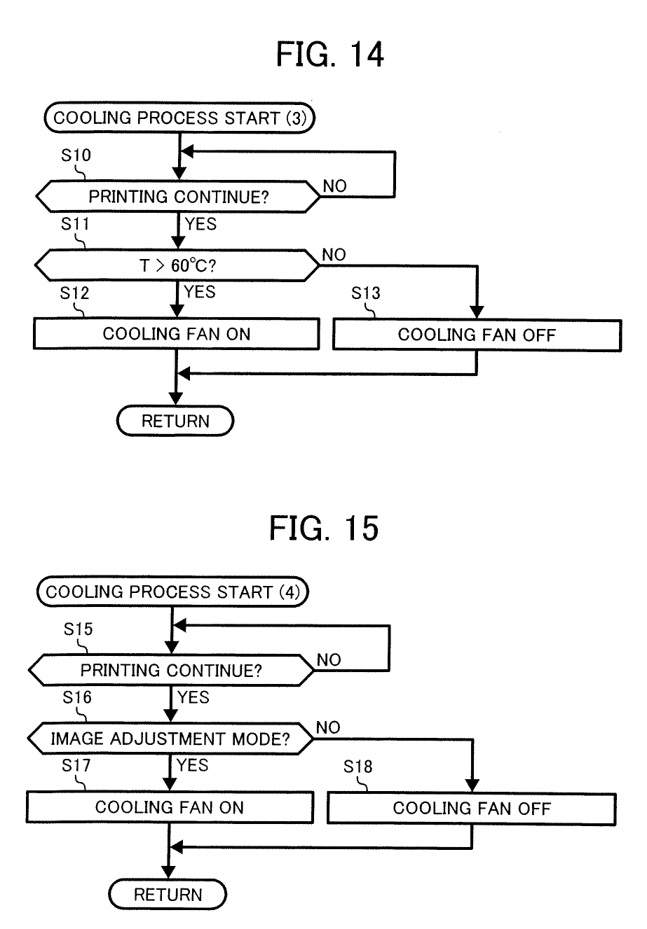

FIG. 14 shows a flow chart of the cooling process (3). It is first determined if printing is continuing in S10, and when YES in S 10 the operation proceeds to S11. In the case the air temperature (T) of the sheet feeding path detected by temperature detecting sensor 403 reaches a predetermined value (YES in S11), the image forming directive part 401 sends a signal to the power supply unit 404 for the fan 303 to be driven (in S12). In this embodiment, the predetermined value is set, as an example, to 60° C. When the temperature is less than the predetermined value (NO in S11), the cooling fan 303 is left off or turned off (S13).

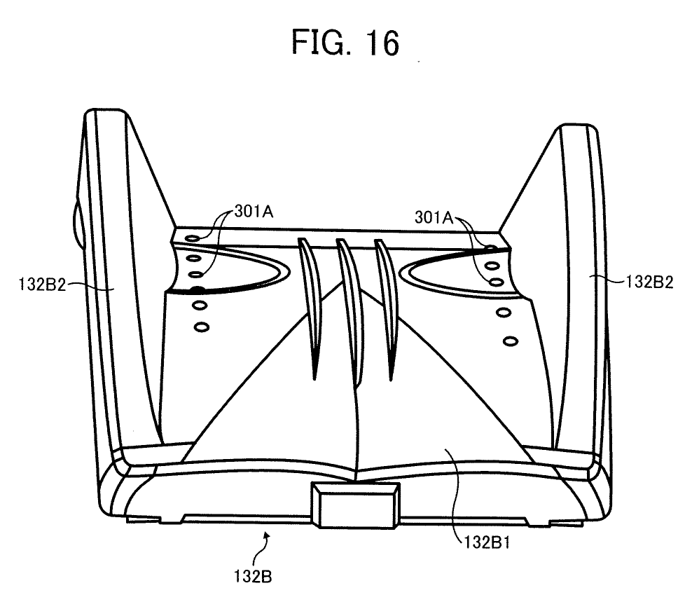

FIG. 15 shows a flow chart of the cooling process (4). It is first determined if printing is continuing in S15, and when YES in S15 the operation proceeds to S16. In the case that the image adjustment mode is carried out (YES in S16), the image forming directive part 401 sends a signal to the power supply unit 404 for the fan 303 to be driven (in S17). The image adjustment mode may be a mode in which an image density or a number of colors of an image on a sheet is being adjusted. That is, in an image adjustment mode test patterns can be recorded onto the transfer belt 122A and an image adjustment can be performed based on reading those test patterns. An image adjustment may adjust an image density or a number of colors of an image on a sheet. In the image adjustment mode, though an image is formed to the transfer belt 122A, the sheet is not fed and the image is not transferred to the sheet. By driving the cooling fan 303 while the image adjustment mode is carried out, the stack of sheets that is discharged on the sheet discharging tray 132 before the image adjustment mode is carried out is cooled continuously and effectively. When no image adjustment mode or after the image adjustment mode is ended, (NO in S16) the fan is off (in S18).

As mentioned above, by the present invention the blocking phenomena as an adhesion of sheets to each other may be prevented by air inducted from outside even if the length to radiate heat of the sheets is short or a series of sheets is stacked up that may insulate radiation of heat of the sheets, because the cooling device 300 is provided nearby the discharging position of the discharging roller 201. The cooling device 300 may cool entirely along the direction in which the sheets are stacked (vertical direction) by supplying air to the sheets. Additionally, the cooling device 300 may cool the middle or upstream portion of the sheet more, where the high temperature parts exist. More additionally, the cooling device 300 may cool the topmost sheet being discharged when the cooling time after fixing is not adequate.

In a case that toner bottles T1-T4 are provided behind the discharging tray 132, the cooling device 300 may prevent decline of quality of toner because heat may not spread to the toner bottles T1-T4.

As illustrated FIG. 16, it is also possible to provide orifices 301A to the sheet accommodating surface 132B1 of the lower part 132B opposite to, at a middle of, or at a downstream portion of the sheet stack to cool the high temperature portion. The air is supplied from not only the orifices 301 of the cooling device 300 illustrated FIG. 2, but also from the orifices 301A. In this case, because the orifices 301A may be covered by the lowermost sheet, the sheets except the lowermost sheet may not be cooled. The cooling efficiency may, however, be increased if the orifices 301A are provided outside of the sheet width. The fresh air will then flow naturally through the orifices 301A. Supplying the fresh air with or without motive energy is adoptable.

Features of the present invention are now summarized.

According to an embodiment of the present invention, the sheet cooling device includes a duct that has a plurality of orifices located along the direction in which the sheets are stacked to induct air to a discharging position of the discharging device. The blocking phenomena caused by adhesion of sheets may be prevented because the air is supplied to the stack of sheet entirely and is allocated most effectively to the hottest position of the stack of sheets.

According to an embodiment of the present invention, the orifices are located at least on one of the side part perpendicular to the sheet feeding direction of the sheet accommodating device. Curl of the sheets may then also be prevented because the cooling device does not intervene with sheet feeding and it becomes possible to supply air to a hot position of the stack of sheets from a close position.

According to an embodiment of the present invention, at least one of the orifices inducts air by a fan to a duct. The heat from the fixing device then hardly heats the air from the fan to the orifice and noise from the fan is decreased.

According to an embodiment of the present invention, at least one of the orifices connected to the duct supplies air in a direction perpendicular to a sheet feeding direction or diagonally beneath. The efficiency to supply the air to the central part that tends to remain heated is then further increased.

According to an embodiment of the present invention, the sheet feeding apparatus includes a fan controller and the fan controller controls the timing of the air supply relative to a sheet discharging timing, the amount of sheets or a sheet stack, an image adjustment mode (such as adjusting the image density or the number of colors of an image on the sheet), or air temperature between the fixing device and the sheet accommodating device. The efficiency of cooling is then increased and dissipation power of the fan is decreased.

Numerous additional modifications and variations of the present invention are possible in light of the above teachings. It is therefore understood that within the scope of the appended claims, the present invention may be practiced other than as specifically described herein.

1. A sheet feeding apparatus comprising:
a fixing device to fix a toner image by heat;
a sheet accommodating device to accommodate a stack of sheets with the fixed toner image;
a sheet feeding device including a sheet discharging device to discharge the sheet and positioned downstream of the fixing device;
a sheet cooling device to cool the sheet with the fixed toner image;
wherein the sheet cooling device is located along the direction in which the sheets are stacked in the sheet accommodating device, wherein the sheet cooling device is located close to the sheet discharging device.

2. The sheet feeding apparatus according to claim 1, wherein the sheet cooling device is at an upstream edge of the sheet accommodating device relative to a sheet feeding direction.

3. The sheet feeding apparatus according to claim 1, wherein the sheet cooling device includes a duct to induct air to a discharging position of the sheet discharging device.

4. The sheet feeding apparatus according to claim 3, wherein the duct includes a plurality of orifices located along the direction in which the sheets are stacked.

5. The sheet feeding apparatus according to claim 4, wherein at least two of the orifices have different sizes from one another.

6. The sheet feeding apparatus according to claim 4, wherein the orifices are located at least at one of a side part perpendicular to the sheet feeding direction of the sheet accommodating device.

7. The sheet feeding apparatus according to claim 4, wherein at least one of the orifices inducts air from an air supply device.

8. The sheet feeding apparatus according to claim 7, wherein the air supply device includes a fan connected to the duct.

9. The sheet feeding apparatus according to claim 8, wherein at least one of the orifices is connected to the duct that supplies air in a direction perpendicular to the sheet feeding direction.

10. The sheet feeding apparatus according to claim 9, wherein at least one of the orifices supplies air in a diagonally lower direction.

11. The sheet feeding apparatus according to claim 8, wherein a volume of air supplied by the fan is variable.

12. The sheet feeding apparatus according to claim 11, further comprising a fan controller, wherein the fan controller controls timing of the air supply relative to a sheet discharging timing.

13. The sheet feeding apparatus according to claim 12, wherein the fan controller includes a detector that detects an amount of sheets stacked on the sheet accommodating device.

14. The sheet feeding apparatus according to claim 12, wherein the fan controller controls an air volume relative to image density or a number of colors of an image on the sheet in an image adjustment mode.

15. The sheet feeding apparatus according to claim 12, wherein the fan controller controls an air supply volume of the fan relative to an air temperature between the fixing device and the sheet accommodating device.

16. The sheet feeding apparatus according to claim 1, wherein the sheet cooling device further includes orifices at a bottom of the sheet accommodating device to discharge air.

17. An image forming apparatus comprising the sheet feeding apparatus according to claim 1.

18. A sheet feeding apparatus, comprising:
a fixing device for fixing a toner image;
a sheet accommodating device to accommodate a stack of sheets with the fixed toner image;
a sheet feeding device including a sheet discharging device for discharging a sheet and positioned downstream of the fixing device;
sheet cooling means for cooling the sheet;
wherein the sheet cooling means is located along the direction in which the sheets are stacked and is located close to the sheet discharging device.

19. An image forming apparatus comprising the sheet feeding apparatus according to claim 18.

20. An image forming apparatus according to claim 18, wherein the sheet cooling means is at a downstream edge of the sheet discharging device.
